(19) United States
(12) Patent Application Publication
(10) Pub. No.: US 2005/0160401 A1
(43) Pub. Date: Jul. 21, 2005

(54) System and method for adding user-defined objects to a modeling tool

(75) Inventors: Mark Russo, Belle Mead, NJ (US); Tad A. Deffler, Boonton, NJ (US)

Correspondence Address: BAKER & MCKENZIE LLP, 805 THIRD AVENUE - 29TH FLOOR, NEW YORK, NY, 10022, US

(73) Assignee: Computer Associates Think, Inc., Islandia, NY (US)

(21) Appl. No.: 10/890,313

(22) Filed: Jul. 12, 2004

Related U.S. Application Data
(63) Continuation-in-part of application No. 09/420,223, filed on Oct. 16, 1999, now Pat. No. 6,859,919.
(60) Provisional application No. 60/486,692, filed on Jul. 11, 2003.

(51) Int. Cl. G06F 9/44

(52) U.S. Cl. 717/108

(57) ABSTRACT

A system and method for adding user-defined object to a modeling tool are provided. In one aspect, a meta-meta model includes at least a plurality of objects, the plurality of objects used to define meta data of a model of a selected domain. A user is enabled to create one or more instances of the plurality of objects to define one or more concepts that describe the selected domain. A user is further enabled to associate the one or more instances to define one or more relationships among the one or more instances.

### CROSS-REFERENCE TO RELATED APPLICATIONS

This application claims the benefit of U.S. Provisional Patent Application No. 60/486,692 entitled SYSTEM AND METHOD FOR ADDING USER-DEFINED OBJECTS TO A MODELING TOOL filed on Jul. 11, 2003. This application is a continuation-in-part application of U.S. patent application Ser. No. 09/420,223, the entire disclosure of which is incorporated herein by reference.

### TECHNICAL FIELD

This application relates generally to computer-related modeling, and more particularly to adding user-defined objects to a modeling tool.

### BACKGROUND

A modeling tool is an application that creates symbolic representations of the components in a specific area of knowledge or activity in order to help visualize the concepts of that area and the operations that can be performed on the components. A software designer, for instance, may use a modeling tool to model a software application before coding. A modeling tool helps the designer to specify, visualize, and document models of software systems, including their structure and design, in a way that meets the requirements of a given software project. Of course, modeling tools may be used for business modeling and modeling of other non-software systems too.

Currently, a broad variety of modeling tools exists, usually each one for targeting one or more specific problem domains. Examples of problem domains include relational database, software development, etc. Such modeling tools generally enable a user to manipulate concepts related to their problem domain in ways that aid in analysis and provide a level of automation in gathering and exploiting their model data. A set of model data, for instance, includes the data components such as objects and properties that make up the model.

A modeling tool such as AllFusion ERwin Data Modeler™ provides these features for the problem domain of relational databases. It enables a user to manipulate components of the relational databases such as tables, columns, and indices. Another example is AllFusion Component Modeler™, which manipulates the concepts related to writing computer software, classes, attributes, and associations.

The currently existing tools provide a fixed set of concepts that a user can manipulate. Accordingly, a modeling tool that enables a user to add new concepts, for example, to meet the user's particular needs is desirable.

### SUMMARY

System and method for adding user-defined objects to a modeling tool are provided. The system in one aspect includes a meta-meta model structured to include at least a plurality of objects and to define relationships among the plurality of objects. The plurality of objects are used to define meta data of a selected domain. A set of application interface functions is operable to create the plurality of objects and to define one or more property values on the plurality of objects.

The method in one aspect includes providing a meta-meta model that includes at least a plurality of objects, the plurality of objects used to define meta data of a model of a selected domain. A user is allowed, for example, via a set of provided application interface functions, to create one or more instances of the plurality of objects, the one or more instances defining one or more concepts that describe the selected domain. A user is further allowed to associate the one or more instances to define one or more relationships among the one or more instances.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates the tables and columns created by the user of a database modeling tool.

FIG. 2 illustrates a meta-meta model for creating a dynamic meta model.

FIG. 3 is another example of a meta-meta model in one embodiment.

FIG. 4 is a flow diagram illustrating a method for adding user-defined objects to a modeling tool in one embodiment.

FIG. 5 is a block diagram of a computer system that may employ the method and system of the present disclosure.

### DETAILED DESCRIPTION

Modeling tools enable users to manipulate and work with concepts that are relevant to their problem domain. Table 1 lists examples of problem domains and the concepts that are addressed in an appropriate modeling tool for that domain.

TABLE 1

| Problem Domain | Concepts to model |
|---|---|
| Database | Tables, columns, |
| | indices, etc. |
| Software | Classes, attributes, |
| application | associations, etc. |
| Drawing tool | box, line, circle, |
| | diagram, etc. |
| workflow tool | process, transition, |
| | participant, etc. |

In using a modeling tool, a user creates and manipulates instances of the concepts within the problem domain. For example, a user of a database modeling tool works with the concepts table, column, and index. During a modeling session, the user may create instances of table such as customer and invoice. The user then provides information that describes what a customer is and what an invoice is. This is done by creating instances of column and associating them with the appropriate table. The instances of table and columns created are a representation of a table. Since actions in a modeling tool are surrogates for actions on the real problem domain, no actual table is created by this operation. However, the modeling data, that is, the instance of a representation of table created, may be used at a later time as a template or definition for the construction of the actual table. The instances of representations of tables and columns may be created by various methods, for instance, by drawing them on a diagram editor, entering them in a property editor, etc.

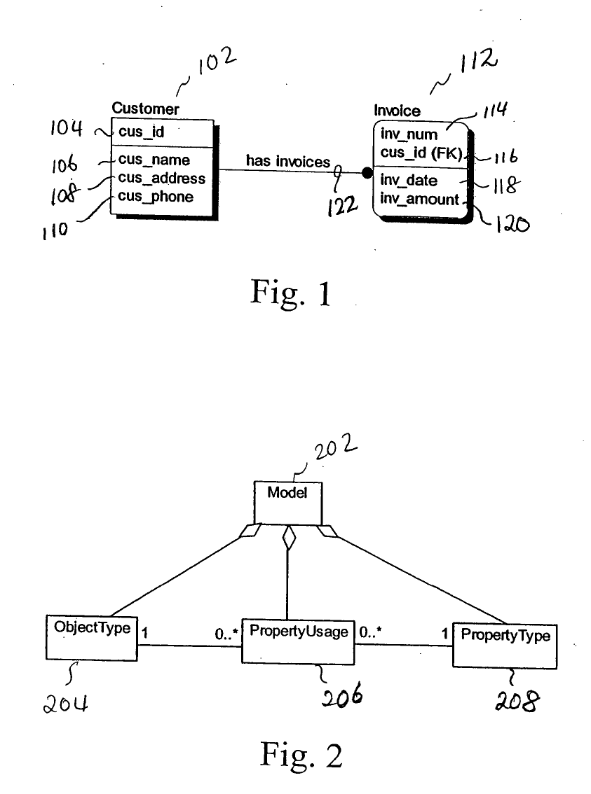

FIG. 1 illustrates the tables and columns created by the user of a database modeling tool. The Customer table 102 includes the columns, cus_id 104, cus_name 106, cus_address 108, and cus_phone 110. The Invoice table 112 includes the columns, inv_num 114, cus_id 116, inv_date 118, and inv_amount 120. A user may further describe the relationship between the customer table 102 and the invoice table 112 by specifying, for example, that the customer 102 has invoices 112 as shown by the line with a filled-in circular head 122.

In one aspect, the system and method of the present disclosure provide the end-users of a modeling tool an ability to add their own object definitions to the set of definitions already understood by the tool, for example, to meet their particular needs. For any modeling tool, the embodiment of the present disclosure extend the tool's usefulness beyond its original design and allow it to be tailored by end-users to address their specific needs.

When creating a tool for database modeling, for example, the authors will build into it knowledge of standard database concepts such as objects like tables and columns and indexes. What the authors may not build in is knowledge of other concepts that are meaningful to a particular customer (user), but are not broadly recognized standards. The system and method of the present disclosure in one embodiment allow customers (users) who have purchased or created extensions to their database software a way for granting this knowledge to their modeling tool so that it may be applied to modeling these extensions.

The present disclosure, in one aspect, illustrates an example of a way for adding such knowledge to a modeling tool. The embodiments described in the present disclosure provide end-users of modeling tool with the ability to add their own object types to the set of object types already understood by the tool.

In one aspect, the present application utilizes a meta model. A meta model stores meta data. Meta data is information that describes other data. A meta model thus includes the collection of “concepts” (also known as things, terms, etc.) that are used to describe a certain domain. For instance, a meta model for a database modeling tool may include the information shown in Table 2. Referring to the “Object Type,” “Table” in Table 2, a user may create data of type “Table” and each instance of the “Table” the user created would represent a table in a database. When the user creates the instance of the “Table,” the user needs to have the instance owned by a “Model” and may set a “name” property on the “Table.”

The actual data would be when the user created a table to hold his customer information and gave it the name, for example, “CUST.”

TABLE 2

| | |
|---|---|
| Object type | Model |
| Definition | Represents the entirety of |
| | the user's electronic |
| | document |
| Property | Name |
| Object type | Table |
| Definition | Each instance of this object |
| | type represents a table in |
| | the database. |
| Owned by | Model |
| Property | Name |
| Object type | Column |
| Definition | Each instance of this object |
| | type represents a column |
| | within table in the database. |
| Owned by | Table |
| Property | Name |
| Property | Datatype |
| Object Type | Index |
| Definition | Each instance of this object |
| | type represents an index on a |
| | table in the database. |
| Owned by | Table |
| Property | Columns_in_index |

Table 2 is an illustrative example of the meta data that is used for a modeling tool to address the problem domain of databases. A modeling tool for software applications would also use meta data, but the particular values would differ and be specific to its problem domain.

In one aspect of the present application, a meta model of a modeling tool that stores meta data such as the one described above with reference to Table 2 is made dynamic. That is, the meta model may be changed by an end-user. The following description provides, in one embodiment, an approach to creating a dynamic meta model.

FIG. 2 illustrates a meta-meta model for creating a dynamic meta model. As meta data is defined as information that describes data, meta-meta data is defined as information that describes meta data. A meta model describes a model, for example, by defining an abstract language for expressing other models; and meta-meta model describes a meta model, for example, by defining an abstract language for expressing meta-models. The notation standard used in FIG. 2 is known as UML (Unified Modeling Language), which is a broadly recognized standard within the software development community. A person having ordinary skill in the art of modeling tools is familiar with UML; further, resources to UML are publicly available on the Internet.

FIG. 2 makes the following assertions about the meta-meta model of a dynamic meta model. The meta-meta model includes four classes of objects: Models 202, Object Types 204, Property Types 208, Property Usage 206. In this example, only one instance of Model 202 exists. The one instance of Model 202 can own any number of instances of Object Type 204, Property Type 208, and Property Usage 206. Each instance of Object Type 204 can be associated with zero or more instances of Property Usage 206. Each instance of Property Type 208 can be associated with zero or more instances of Property Usage 206. Each instance of Property Type 208 is associated with one instance of Object Type 204 and one instance of Property Type 208. Persons of ordinary skill will recognize that other meta-meta models can be used for describing a dynamic meta model. Thus, the meta-meta model shown in FIG. 2 is shown only as an example for further providing description of the dynamic meta model in one embodiment.

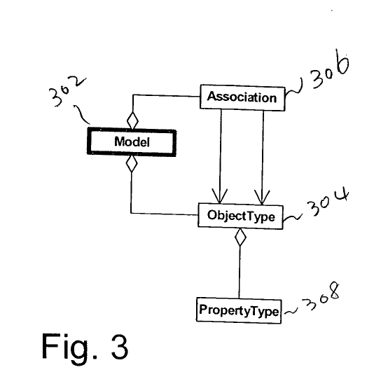

Another example of a meta-meta model is shown in FIG. 3. In this example, the meta-meta model includes four classes of objects: Model 302, Object Type 304, Association 306, and Property Type 308. The instance of the Model 302 can own an Object Type 304 instance and an Association 306 instance. The Object Type 304 instance can own a Property Type 308 instance. The Association 306 instance can be associated with two instances of Object type 304. With the meta-meta models provided as in FIG. 2 or FIG. 3, a user can modify or add to a meta model.

In one embodiment, creating a software component that implements the meta-meta model in FIG. 2 provides the basis of a dynamic meta model. The software component, for example, may include classes that represent Model, ObjectType, PropertyType, and PropertyUsage. The software component would also include functions for creating instances of these objects and functions for setting properties on these objects. A person having ordinary skill in the art would be able to implement such a component without requiring extensive explanation of all technical details involved.

For example, new object types may be created within the dynamic meta model. In order to allow end-users to define their own object types, a modeling tool that implements a dynamic meta model as described with reference to FIG. 2, exposes or makes available one or more functions within its API (application programming interface) that facilitate the creation of object type definitions. Table 3 describes such functions.

TABLE 3

| | |
|---|---|
| FunctionName | CreateObject |
| Return value | A unique identifier for the |
| | newly created object |
| Parameter 1 | The name for the new object |
| Parameter 2 | The identifier that specifies |
| | the type of the new object. |
| | Valid values for this |
| | parameter are: ObjectType, |
| | PropertyType, PropertyUsage |
| Function Name | SetProperty |
| Return value | No value is returned |
| Parameter 1 | An object identifier |
| Parameter 2 | A PropertyType identifier |
| Parameter 3 | The value for the property |

In the above CreateObject( ), the first parameter is the type name of what is being created, a way to reference a particular instance. The second parameter is the meta-meta type to be created. The return value of the function is a reference to the instance of the object created. In the above SetProperty( ), the first parameter is a reference to the object upon which a property is being set. The second parameter is the type of property being set. The third parameter is the value to be set.

The CreateObject function may be used by a modeling tool to define its own meta data at run-time. A database modeling tool, for example, may make the following function calls when the tool is first launched.

To create the object type:
objTable=CreateObject (“Table”, ObjectType)
objColumn=CreateObject (“Column”, ObjectType)
objindex=CreateObject (“Index”, ObjectType)

To create the property types:
propName=CreateObject (“Name”, PropertyType)

To associate the Name property type with the Table object type:

usageTableName = CreateObject( “”, PropertyUsage
)
SetProperty( usageTableName, propObjectType,
objTable )
SetProperty( usageTableName, propPropertyType,
propName )

To specify ownership of objects:

OwnerList = { objModel }
SetProperty( objTable, propValidOwners, OwnerList
)
OwnerList = { objTable }
SetProperty( objColumn, propValidOwners,
OwnerList )
SetProperty( objIndex, propValidOwners, OwnerList
)

In the above example that specifies the ownership, “propValidOwners” may be another ObjectType that is created using the CreateObject function. Once the modeling tool has finished defining its built-in meta model, the end-user can begin defining their own set of object types. Through the API that allows users to invoke the above-defined routines, an end-user may define a new object type as illustrated below.

To create a user's own object type, for example, AuditRecord:
objAuditRecord=CreateObject (“AuditRecord”, ObjectType)

The “AuditRecord” object type, for example, may be defined and added to the modeling tool, to meet a user's particular need to include audit records for any changes made to an object.

To associate the Name property type with the above created user's own object type:

usageAuditName = CreateObject ( “”, PropertyUsage )
SetProperty( usageAuditName, propObjectType,
objAuditRecord )
SetProperty( usageAuditName, propPropertyType,
propName )

In the above example, the CreateObject function creates an instance of the “PropertyUsage” meta-meta type. The instance created is returned in “usageAuditName” as a pointer or reference value. The first SetProperty function call above associates usageAuditName with AuditRecord Object Type. The second SetProperty function call above associates usageAuditName with a name property.

To specify the owner of the user's object AuditRecord as the table,
OwnerList={objTable}
SetProperty(objAuditRecord, propValidOwners, OwnerList)

The preceding examples described the structural aspects of a meta model, specifically, what types of data could be represented and the associations between such data. In one embodiment, to support the structural portion of its meta model, a modeling tool verifies that only known object and property types are instantiated, that only the permitted properties are set for each object type, and that object instances are owned only by an instance of one of the permitted owner object type.

Another aspect of a meta model is the behavior and rules that are associated with the data. U.S. patent application Ser. No. 09/420,223 dicusses a modeling engine supporting both the structural and behavioral aspects of meta models and introduces the concept of semantics in a meta model. Semantics are the rules that govern the data to be modeled and are automatically enforced when model data is changed. The following sample semantic is applicable to a database modeling tool and is presented to clarify the concept of semantics and how they are applied to modeling.

Semantic #1

Definition:

The names in the model must be unique.

Implementation (Psuedo-Code):

For each Table in the model
{

if current Table name is equal to the

proposed Table name

Return failure code to reject the

proposed Table name

}

Return success code to accept the proposed Table name.

Once a semantic has been defined and implemented, it is registered with the meta model to ensure its enforcement. The following pseudo-code illustrates this.

To register the unique-name semantic for Tables:
RegisterSemantic (objTable, “Semantic #1”)

A modeling tool can employ this semantic technique to ensure the validity of model data as changes are made by the end-user. The modeling tool is expected to register its semantics as illustrated above immediately after the tool is launched by the end-user. Once the semantic registration process is complete, the end-user can register their own semantics using the same API employed by the tool for its own needs.

Semantics provided by the end-user can be registerd against both the object and property types built into the modeling tools and those types defined by the end-user. The following semantics provide an example of how semantics may be employed by the end-user.

MySemantic #1

Definition:

Changes to Table names must be logged in an AuditRecord.

Implementation (Pseudo-Code):

Create new AuditRecord;

Store today's date in the AuditRecord.

Store the user's name in the AuditRecord.

Store the old and new Table names in the AuditRecord.

MySemantic #2

Definition

Only the last ten AuditRecord should be retained

Implementation (Pseudo-Code)

If count of AuditRecords for this Table is greater than 10

Delete all but the most recent 10 AuditRecords.

With these semantics defined and implemented, the end-user would register them into the modeling tool's meta model. The following pseudo-code illustrates this:

To register the name-logging semantic for Tables:
RegisterSemantic (objTable, “MySemantic #1”)

To register the audit-limit semantic:
RegisterSemantic (objAuditRecord, “MySemantic #2”)

These sample semantics demonstrate that semantics provided by the end-user can be registered against both the modeling tool's built-in meta data and the meta data provided by the end-user.

The above examples described both the structural and behavioral aspects of a meta model. Taken together, these aspects provide a definition of the meta data managed by a modeling tool. A modeling tool that supports and enforces the structural and behavioral meta model rules for both built-in and end-user-provided meta data offers end-users the ability to extend and customize the modeling tool to meet their particular needs.

One aspect of the present application allows the end-users to provide their own structural definition of their own object types, and to provide their own semantics to govern any available object type whether their own or built into the modeling tool, for example, by making the function calls available to the users via an API.

The present application provides a method for modeling tools to make their meta models fully dynamic and to enable the end-user to add their own complete object type definitions to the tool. In another aspect, the method and system described in the present application provides automatic enforcement of the structural aspects of the meta model.

In one embodiment of the present application, a CreateObject( ) function is provided to allow the meta models to be dynamic. The CreateObject( ) function takes a parameter to indicate what sort of object is to be created; an object type, a property type, or a property usage. In another embodiment, similar functionalities may be implemented by providing or exposing API functions as shown in Table 4.

TABLE 4

| | |
|---|---|
| Function | CreateObjectType |
| Name | |
| Return | A unique identifier for the |
| value | newly created object type. |
| Parameter 1 | The name for the new object |
| Function | CreatePropertyType |
| Name | |
| Return | A unique identifier for the |
| value | newly created property type. |
| Parameter 1 | The name for the new property |
| | type |
| Function | CreatePropertyUsage |
| Name | |
| Return | A unique identifier for the |
| value | newly created property usage. |
| Parameter 1 | The identifier of the object |
| | type to associate with the |
| | property usage. |
| Parameter 2 | The identifier of the property |
| | type to associate with the |
| | property usage. |

Including such functions in the API enables the user to define a new object type as described above.

In a further embodiment, a meta model may include a generic object type to simulate the above describe functionality for allowing users to define their own object types. The generic object type may be used as a substitute for true user-defined objects. For example, in a meta model that includes a generic object type, the structural meta model rules may be relaxed to permit instances of the generic object type to be owned by instances of any object type. Instances of the generic object type may be also permitted to own other instances of the generic object type. The structural meta model rules are relaxed also to allow any property type to be used with the generic object type. The meta model provides a property that may be set on these generic objects to indicate the object type the end-user may specify.

For example, an end-user may call an API function to create an instance of the generic object type to create an AuditRecord. A property may be set on the new generic object instance that indicates that it is an AuditRecord. Other desired properties may be set on the new generic object instance to store the audit-related data.

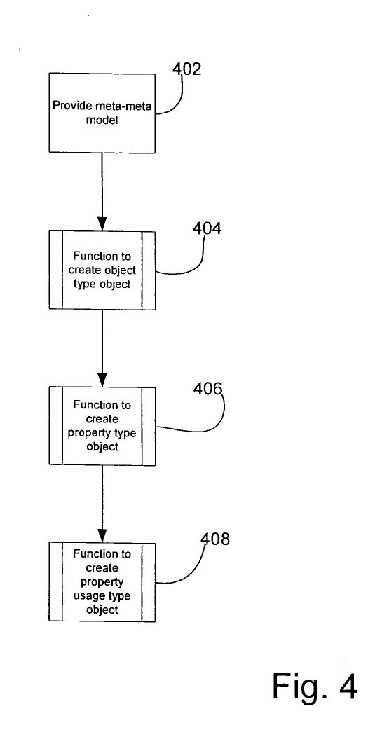

FIG. 4 is a flow diagram illustrating a method of adding user-defined objects to a modeling tool in one embodiment. At 402, meta-meta model such as shown in FIG. 2 or FIG. 3 is provided. At 404, an interface function to create object type objects is provided. A user, for instance, invoking the interface function can create objects to define particular object types according to the user's needs. At 406, an interface function to create property type objects is provided. A user, for instance, may invoke this interface function to create objects that are property types for describing the object type object. At 408, an interface function to create property usage objects is provided. A user, for instance, may invoke this interface to associate the object type object with any property type objects created.

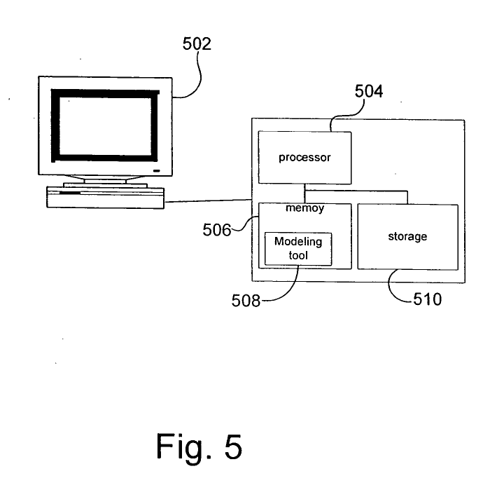

FIG. 5 is a block diagram of a computer system that may employ the method and system of the present disclosure in one embodiment. A computer system 502, for example, a personal computer or a workstation, capable of executing modeling tool programs may include a processor 504, memory 506, and storage 510 device drivers to access more permanent storage devices such as hard disk, removal floppy disk, DVD, CD, or any other storage device known or will be known in the future. The devices 504, 506, 508, and 510 are, for example, connected by a bus. The memory 506 is capable of loading at least a portion of the modeling tool programs 508 for execution on the processor 504.

The system and method of the present disclosure may be implemented and run on a general-purpose computer. For example, the system and method may be implemented as set of computer instructions to be stored on computer memory units and executed on the computer processor. The embodiments described above are illustrative examples and it should not be construed that the present invention is limited to these particular embodiments. For example, although specific types of modeling tools are discussed as examples above, the embodiments of the present disclosure are applicable to any variety of modeling tools. Thus, various changes and modifications may be effected by one skilled in the art without departing from the spirit or scope of the invention as defined in the appended claims.

1. A method for adding user-defined objects to a modeling tool, comprising:
providing a meta-meta model that includes at least a plurality of objects, the plurality of objects used to define meta data of a model of a selected domain;
allowing a user to create one or more instances of the plurality of objects, the one or more instances defining one or more concepts that describe the selected domain; and
allowing a user to associate the one or more instances to define one or more relationships among the one or more instances.

2. The method of claim 1, further including:
allowing a user to define one or more behavioral rules associated with the one or more instances.

3. The method of claim 1, further including:
providing a set of application interface functions for creating the one or more instances of the plurality of objects that conform to the meta-meta model.

4. The method of claim 3, wherein the set of application interface functions include a function to create an object and a function to set a property value on an object created.

5. The method of claim 3, wherein the set of application interface functions include:
a function to create,an object type object;
a function to create a property type object; and
a function to create a property usage object for associating a created object type object with a created property type object.

6. The method of claim 1, wherein the providing a meta-meta model includes:
providing an object type object;
providing a property type object;
providing a property usage type object; and
providing one or more rules specifying one or more relationships among the object type object, the property type object, and the property usage type object.

7. A system for adding user-defined objects to a modeling tool, comprising:
a meta-meta model structured to include at least a plurality of objects and defining relationships among the plurality of objects, the plurality of objects used to define meta data of a selected domain; and
a set of application interface functions operable to create the plurality of objects and to define one or more property values on the plurality of objects.

8. The system of claim 7, wherein the meta-meta model includes at least an object type, a property type, and a property usage type.

9. The system of claim 7, wherein the meta-meta model includes at least an object type, a property type, and an association type.

10. The system of claim 7, wherein the set of application interface functions includes at least:
a create object type module operable to create one or more object type objects;
a create property type module operable to create one or more property type objects; and
a create property usage module operable to associate the one or more property type objects with the one or more object type objects.

11. The system of claim 10, wherein the set of application interface functions further include:
a module operable to define one or more behavioral rules associated with an object type object, a property type object, or combinations thereof.

12. A program storage device readable by machine, tangibly embodying a program of instructions executable by the machine to perform a method for adding user-defined objects to a modeling tool, comprising:
providing a meta-meta model that includes at least a plurality of objects, the plurality of objects used to define meta data of a model of a selected domain;
allowing a user to create one or more instances of the plurality of objects, the one or more instances defining one or more concepts that describe the selected domain; and
allowing a user to associate the one or more instances to define one or more relationships among the one or more instances.

13. The program storage device of claim 12, further including:
allowing a user to define one or more behavioral rules associated with the one or more instances.

14. The program storage device of claim 12, further including:
providing a set of application interface functions for creating the one or more instances of the plurality of objects that conform to the meta-meta model.

15. The storage device of claim 14, wherein the set of application interface functions include a function to create an object and a function to set a property value on an object created.

16. The storage device of claim 14, wherein the set of application interface functions include:
a function to create an object type object;
a function to create a property type object; and
a function to create a property usage object for associating a created object type object with a created property type object.
